(19) United States
(12) Patent Application Publication
(10) Pub. No.: US 2009/0004472 A1
(43) Pub. Date: Jan. 1, 2009

(54) INSULATED CONDUCTOR AND METHOD FOR MANUFACTURING SAME

(75) Inventors: Kenichiro FUJIMOTO, Hitachi (JP); Tomiya ABE, Hitachi (JP)

Correspondence Address: SCULLY SCOTT MURPHY & PRESSER, PC, 400 GARDEN CITY PLAZA, SUITE 300, GARDEN CITY, NY, 11530, US

(73) Assignee: HITACHI CABLE, LTD., Tokyo (JP)

(21) Appl. No.: 12/145,055

(22) Filed: Jun. 24, 2008

(30) Foreign Application Priority Data
Jun. 25, 2007 (JP) 2007-166954

(51) Int. Cl. B32B 15/00

(52) U.S. Cl. 428/379; 428/332

(57) ABSTRACT

An insulated conductor includes a conductor, and an insulation covering the conductor and formed of a resin composition. The resin composition includes more than 60% by weight of polybutylene naphthalate resin. The resin composition further includes a hydrogenated block copolymer that a block copolymer including a styrene and a diene system compound is saturated by hydrogenation, and at least one of a polyolefin and a compound including a glycidyl group. A method for manufacturing the insulated conductor includes forming on the conductor the insulation including the resin composition by extrusion in a range of 290° C. to 310° C.

The present application is based on Japanese Patent Application No. 2007-166954 filed on Jun. 25, 2007, the entire contents of which are incorporated herein by reference.

### BACKGROUND OF THE INVENTION

1. Field of the Invention

The invention relates to an insulated conductor, in more particular, to an insulated conductor with an insulation including a resin composition that comprises mainly a polybutylene naphthalate resin. Also, the invention relates to a method for manufacturing the insulated conductor.

2. Related Art

An insulation formed of a polyvinyl chloride resin (PVC) has been conventionally used. The PVC insulation is high in practical characteristics and low in cost.

However, when incinerating the PVC insulation after being disposed, environmental pollution problem arises which is associated with waste disposal such as generation of gas containing chlorine. Furthermore, in the transportation field such as vehicles, trains or the like, a lighter and thinner electric insulating wire is required to achieve car body lightening and space saving of wiring to seek energy conservation. However, the PVC material is not satisfactory for stimulating weight saving and thinning of wires in respect of flame resistance, heat resistance, abrasion resistance or the like.

As a material other than the PVC, a polyester resin which is a general purpose engineering plastic polymer, especially a polybutylene terephthalate (PBT) resin which is a crystalline polymer, is now used. The PBT resin does not generate gases containing chlorine even when being incinerated, thus, no environmental pollution problem arises which is associated with waste disposal. Furthermore, since it is excellent in heat resistance, abrasion resistance, electrical characteristics, chemical resistance, formability, also excellent in dimension stability due to small water-absorbing property and flame proofing is relatively easy, it is used in a wide range of fields such as an automotive field, an electrical/electronic field, an insulation field, an OA field or the like (for example, see JP-A 2002-343141) Since the PBT resin has the above characteristics, there is a prospect for achieving a weight saving and thinning of the wire while maintaining flame resistance and abrasion resistance. However, in recent years, further improvement in heat resistance and mechanical characteristics is required for the insulation of the electric wire, and it is difficult to achieve by the PBT resin.

Therefore, as an insulating material in which a further improvement in heat resistance and mechanical characteristics can be expected, a polyethylene naphthalate (PEN) resin with a naphthalene skeleton or a polybutylene naphthalate (PBN) is possible. In this regard, JP-A 6-107917 discloses a resin composition using PBN and JP-A 2004-193117 discloses an insulated conductor using PEN or PBN.

Although the PEN resin is excellent in heat resistance and mechanical characteristics, it is not a suitable material as a wire/cable material in respect of flexibility and elongation characteristic as it is very rigid.

The PBT resin has heat resistance mechanical strength more excellent than the PBT resin. Here, sufficient abrasion resistance and tensile elongation characteristics are required for the insulation coating a wire so as to achieve weight saving and thinning of the wire. However, neither of JP-A 6-107917 and JP-A 2004-193117 concretely considers or offers to realize these characteristics.

### THE SUMMARY OF THE INVENTION

It is an object of the invention to provide an insulated conductor that can exhibit excellent abrasion resistance and tensile elongation characteristics, and a method for manufacturing the insulated conductor.

(1) According to one embodiment of the invention, an insulated conductor comprises:

a conductor; and

an insulation covering the conductor and comprising a resin composition,

wherein the resin composition comprises more than 60% by weight of polybutylene naphthalate resin.

In the above embodiment (1), the following modifications and changes can be made.

(i) The resin composition further comprises a hydrogenated block copolymer that a block copolymer comprising a styrene and a diene system compound is saturated by hydrogenation, and at least one of a polyolefin and a compound comprising a glycidyl group.

(2) According to another embodiment of the invention, an insulated conductor comprises:

a conductor; and

an insulation covering the conductor and comprising a resin composition,

wherein the resin composition comprises more than 60% and not more than 100% by weight of polybutylene naphthalate resin, 0 to 20% by weight of a hydrogenated block copolymer that a block copolymer comprising a styrene and a diene system compound is saturated by hydrogenation, and 0 to 20% by weight of at least one of a polyolefin and a compound comprising a glycidyl group.

In the above embodiment (1) or (2), the following modifications and changes can be made.

(ii) The hydrogenated block copolymer comprises a PS-polyethylene/butylene-PS triblock copolymer.

(iii) The polyolefin comprises a low-density polyethylene, and

the compound comprising the glycidyl group comprises an ethylene-glycidyl methacrylate copolymer.

(iv) The resin composition further comprises 5 to 40% by weight of a nitrogen-containing compound with respect to 100% by weight of the resin composition.

(v) The insulation comprises a thickness of 0.01 mm to 0.3 mm.

(3) According to another embodiment of the invention, a method for manufacturing an insulated conductor comprises:

forming on the conductor the insulation comprising the resin composition according to claim 1 by extrusion in a range of 290° C. to 310° C.

### BRIEF DESCRIPTION OF THE DRAWINGS

Next, the present invention will be explained in more detail in conjunction with appended drawings, wherein:

FIG. 1 shows mixture of resin composition, extrusion temperature and results of evaluation test of each characteristic in embodiments and comparative examples; and

FIG. 2 is an explanatory diagram showing a test method of abrasion resistance.

### DESCRIPTION OF THE PREFERRED EMBODIMENTS

Preferred embodiments according to the invention will be explained as below.

An insulated conductor (or wire) in the preferred embodiment of the invention comprises a conductor coated with a resin composition as an insulation containing more than 60% by weight of polybutylene naphthalate resin at an extrusion temperature of 290° C. to 310° C.

The resin composition may include a hydrogenated block copolymer that a block copolymer of a styrene and a diene system compound is saturated by hydrogenation, and at least one of a polyolefin and a compound including a glycidyl group.

The PBN resin used in the above embodiment includes as a main acid component naphthalene dicarboxylic acid, preferably 2,6-naphthalene dicarboxylic acid and the main glycol component is diol, preferably 1,4 butanediol. It may be a conventionally-known polyester resin as long as it consists mainly of a PBN resin synthesized by the acid component and the glycol component, and the molecular structure thereof is not limited specifically.

Furthermore, a fixed viscosity of the above PBN resin is preferably 0.6 dl/g or more since the PBN resin having a low fixed viscosity is inferior in mechanical characteristics.

Furthermore, in the PBN resin composition, a PBN content is preferably over 60% by weight since there is a possibility to damage excellent heat resistance, abrasion resistance and tensile elongation characteristics of the PBN resin depending on characteristics of other contained resins or the like when being 60% by weight or less. Furthermore, the PBN content of the resin composition is more preferably 70% to 100% by weight.

The hydrogenated block copolymer is a hydrogenated block copolymer obtained by saturating double bonds in a block copolymer of styrene and diene system compound by hydrogenation. This hydrogenated block copolymer includes, for example, a hydrogenated block copolymer obtained by saturating double bonds in a styrene-butadiene block copolymer such as a styrene-butadiene-styrene block copolymer (SBS), a styrene-butadiene rubber block copolymer (SBR) or the like, or a styrene-isoprene block copolymer such as a styrene-isoprene-styrene block copolymer (SIS), a styrene-isoprene rubber block copolymer (SIR) or the like, by hydrogenation. In particular, the hydrogenated block copolymer is preferably a PS-polyethylene/butylene-PS triblock copolymer (SEBS).

The above block copolymer may be denatured by an organic carboxylic acid if necessary.

The content in the resin composition of the hydrogenated block copolymer is preferably 0 to 20% by weight since the rate of polyester content in the overall resin composition decreases and the intrinsic excellent heat resistance and abrasion resistance of the polyester are damaged when the amount of the above hydrogenated block copolymer exceeds 20% by weight.

For example, the polyolefin is preferably low-density polyethylene. The additive amount of the polyolefin composition is preferably 0 to 20% by weight since the rate of polyester content in the overall resin composition decreases and the intrinsic excellent heat resistance and abrasion resistance of the polyester are damaged when the polyolefin composition exceeds 20% by weight.

Although the compound including the glycidyl group includes triglycidyl cyanurate, monoallyl diglycidyl cyanurate, ethylene-glycidyl methacrylate copolymer or the like, the ethylene-glycidyl methacrylate copolymer is especially desirable. Here, the compound including the glycidyl group is used as a compatiblizer (or compatible solvent).

The additive amount of the compound including the glycidyl group is preferably 0 to 20% by weight. If the compound including the glycidyl group exceeds 20% by weight which is the above upper limit, the reactivity increases when kneading the above resin composition, a melt viscosity of the resin rises and thus the kneading becomes difficult. Therefore, even though a wire is formed, the appearance of the wire deteriorates significantly.

Furthermore, a content of the polyolefin or/and the compound including the glycidyl group is more preferably 0 to 20% by weight.

Furthermore, to improve flame resistance, a nitrogen-containing compound may be added to the above resin composition. Although the nitrogen-containing compound includes, for example, melamine cyanurate, melamine, a cyanuric acid, a isocyanuric acid, a triazine derivative, a isocyanuric derivative or the like, the melamine cyanurate is especially desirable.

The melamine cyanurate is used in particulate, even though the surface is untreated, a surface finishing may be conducted by applying a finishing agent such as a coupling agent (an aminosilane coupling agent, an epoxysilane coupling agent, a vinylsilane coupling agent, etc.) or a higher fatty acid (a stearic acid, an oleic acid, etc.) or the like.

The above nitrogen-containing compound is desirably formulated 5 to 40% by weight with respect to 100% by weight of the resin composition. Furthermore, 5 to 30% by weight of formulation is more preferable. When the nitrogen-containing compound exceeds 40% by weight, the abrasion resistance of the resin composition decreases, meanwhile it is not possible to obtain enough flame-retardant effect when being less than 5% by weight.

Furthermore, to improve and adjust molding processability and a physical property of molding, it is possible to formulate other resins or various additives to the above resin composition with the amount within the range in which the characteristics required for the above resin composition is not damaged. The additive includes, for example, an antioxidant, a toughening agent, a bulking agent, a heat stabilizer, an ultraviolet absorber, a lubricant, a pigment, a dye compound, a plasticizer, a crystal nucleating agent, a hydrolysis inhibitor or the like.

Furthermore, an insulated conductor in another preferred embodiment of the invention may include, as an insulation of the conductor (or wire), a resin composition that comprises 60 to 100% by weight of the PBN resin, 0 to 20% by weight of the hydrogenated block copolymer where the block copolymer of styrene and diene compound is saturated by hydrogenation, and 0 to 20% by weight of the polyolefin or/and the compound including the glycidyl group.

A method for manufacturing the insulated conductor (or wire) in the preferred embodiment of the invention will be explained below.

It is possible to use a known method for manufacturing the electric wire, for example, it is possible to manufacture by using a general extrusion molding line, melting and kneading the resin composition and extruding a composition consisting mainly of a PBN resin on a conductor. For example, a batch-type kneading machine or a twin screw extruder is used for melt kneading. For example, a twin screw extruder is used for an extrusion molding line. Extruders other than twin screw may be also used for the extrusion molding line. The molten and kneaded resin composition is extruded by this twin screw extruder controlling a temperature of a head portion of the twin screw extruder at a predetermined temperature within the range of 290° C. to 310° C. and the conductor is coated with the resin composition at the extrusion temperature of 290° C. to 310° C.

As for the conductor, a copper wire may be used as a single line, or a twisted wire or a twined wire comprising multiple wires. Hot-dip plating or tin plating by electrolysis may be applied to the copper wire. Furthermore, the insulated conductor is only needed that the periphery of the conductor is coated with the resin composition, and there is an insulated conductor having a structure in which the periphery of the conductor is coated with the resin composition and further coated the periphery thereof with a sheath layer, or the one having a structure in which a plurality of the conductors coated with the resin composition are twisted together and the periphery thereof is coated with a sheath layer in other embodiments.

Furthermore, the extrusion temperature of the above resin composition is preferably within the range of 290° C. to 310° C. If the temperature exceeds 310° C., the resin composition may be partially decomposed or the decrease in molecular weight of PBN may cause a foreign substance in a bumped shape or a defect in an outer diameter of the wire. Furthermore, if the temperature falls below 290° C., the PBN resin does not melt completely and it may lead to the cause of a defective appearance or the impossibility of extrusion may occur.

Furthermore, the thickness of the insulation consisting of the above resin composition coating the conductor is preferably within the range of 0.1 to 0.3 mm so as to seek weight saving and thinning of the wire. If the thickness of the insulation falls below 0.01 mm, the maintenance of abrasion resistance becomes difficult. Furthermore, the diameter of the conductor is preferably within the range of 1 to 2 mm. In the meantime, a cross-section shape of the conductor is not limited to a round shape, it may be a rectangular shape obtained by a slit processing from a flattened copper plate or rolling a round wire.

In the insulated conductor in the above preferred embodiment, since the resin composition comprising mainly the PBN resin having excellent abrasion resistance and tensile elongation characteristics is used for an insulation, even if the weight is trimmed and the thickness is reduced, it is possible to obtain an insulated conductor having excellent mechanical strength and heat resistance, and it is thus preferable, for example, as a wire on vehicle such as an automotive or a train.

### EXAMPLES

Examples of the invention as well as Comparative Examples will be explained as below.

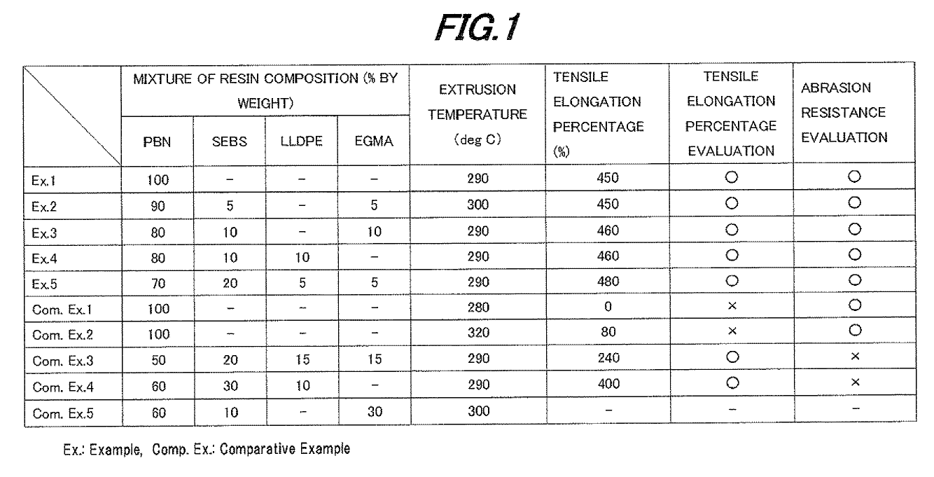

FIG. 1 shows mixture of resin composition, extrusion temperature and results of evaluation test of each characteristic in Examples and Comparative Examples. Samples used for the evaluation test are manufactured as below.

In the resin compositions in Examples and Comparative Examples shown in FIG. 1, TQB-OT, a product of Teijin Chemicals LTD., is used for a polybutylene naphthalate resin (PBN). A composition is mixed at a formulation shown in FIG. 1, molten and kneaded at 290° C. using a twin screw extruder, made the obtained kneaded composition to a pellet by crushing up to the rice grain size and vacuum dried by a vacuum dryer at 120° C. for 10 hours. Next, the resin composition obtained by the above processing is extruded on the periphery of the tin-plated copper wire of 1.3 mm in a diameter with a cladding thickness of 0.3 mm. A dice and a nipple with 4.2 mm and 2.0 mm in respective diameters are used for the extrusion molding at 5 m/min of the extrusion speed, at the extrusion temperature of 270° C. to 290° C. in a cylinder portion and 280° C. to 320° C. in a head portion.

The abbreviations in FIG. 1 are as below.

SEBS: PS-polyethylene/butylene-PS triblock copolymer

LLDPE: Linear low-density polyethylene

EGMA: Ethylene-glycidyl methacrylate copolymer

The characteristics evaluation is tested by the following method.

(1) Tensile Elongation Test

A copper wire is taken out from the above sample of the insulated conductor, a tubular sample piece (1.9 mm in outer diameter, 1.3 mm in inner diameter and 150 mm in length) is manufactured, and then, the tensile elongation test is conducted using this sample. The tensile elongation test is carried out to the sample piece at 200 mm/min of tensile speed in according with JIS C 3005. 200% or more of the tensile elongation percentage is “◯” (i.e., passed) and others are “x” (i.e., failed).

The tensile elongation percentage is calculated by the following formula.

Tensile elongation percentage (%)=[(Length of sample after tensile test)=(Length of sample before tensile test)]×100/(Length of sample before tensile test)

(2) Abrasion Resistance Test

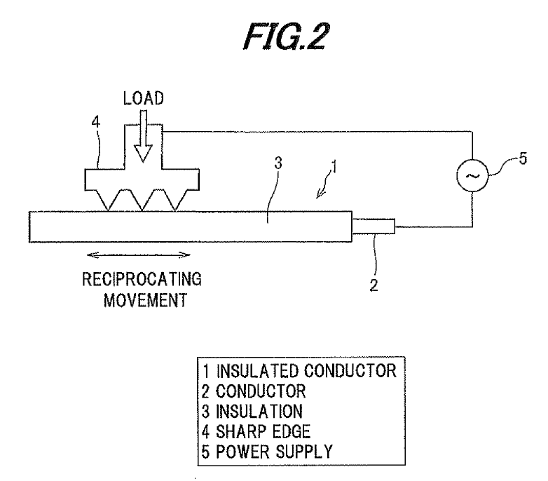

An abrasion resistance test is conducted to the insulated conductor (0.3 mm in a cladding thickness and 60 cm in length of the insulation) manufactured as mentioned above using an abrasion tester in a normal atmosphere of normal temperature. In this abrasion resistance test, as shown in FIG. 2, a 90° sharp edge 4 of the abrasion tester is applied to an insulated conductor 1 from above and the insulated conductor 1 is pressed by the 90° sharp edge 4 adding 2 pounds (907 g) of load. In this state that the load is applied, the insulated conductor 1 is reciprocated in the longitudinal direction thereof, and the frequency (cycle) of a reciprocating movement until an insulation 3 of the insulated conductor 1 is abraded away and the 90° sharp edge 4 contacted with a conductor 2 and shorted, is measured. A power supply 5 and a lamp for detecting short-circuit (not shown) are connected between the conductor 2 of the insulated conductor 1 and the 90° sharp edge 4.

100 times or more of the frequency (cycle) of the reciprocating movement until short-circuit is “◯” (i.e., passed) and less than 100 times is “x (or failed)” (i.e., failed).

In the result of experimental evaluation of the above tensile elongation percentage and abrasion resistance, the resin compositions in Examples 1 to 5 are “◯” for all.

However, the compositions obtained in Comparative Examples 1 to 5 cannot obtain a target characteristic.

For example, as in Comparative Example 1, when the extrusion temperature is as low as 280° C., there is no elongation characteristic and the tensile elongation percentage is 0%. This is considered because of insufficient melting of the PBN resin. Meanwhile, as in Comparative Example 2, when the extrusion temperature is as high as 320° C., the tensile elongation percentage is significantly as small as 80%. Furthermore, when the PBN content is less than the predefined amount as in Comparative Example 3 and when the SEBS is greater than the predefined amount as in Comparative Example 4, at least the elongation characteristics are satisfied, however, the abrasion resistance is not sufficient. Furthermore, as in Comparative Example 5, when the EGMA content is too much, the appearance of the wire becomes significantly uneven and it is not possible to evaluate.

Although the invention has been described with respect to the specific embodiments for complete and clear disclosure, the appended claims are not to be therefore limited but are to be construed as embodying all modifications and alternative constructions that may occur to one skilled in the art which fairly fall within the basic teaching herein set forth.

What is claimed is:

1. An insulated conductor, comprising:
a conductor; and
an insulation covering the conductor and comprising a resin composition,
wherein the resin composition comprises more than 60% by weight of polybutylene naphthalate resin.

2. The insulated conductor according to claim 1, wherein:
the resin composition further comprises a hydrogenated block copolymer that a block copolymer comprising a styrene and a diene system compound is saturated by hydrogenation, and at least one of a polyolefin and a compound comprising a glycidyl group.

3. An insulated conductor, comprising:
a conductor; and
an insulation covering the conductor and comprising a resin composition,
wherein the resin composition comprises more than 60% and not more than 100% by weight of polybutylene naphthalate resin, 0 to 20% by weight of a hydrogenated block copolymer that a block copolymer comprising a styrene and a diene system compound is saturated by hydrogenation, and 0 to 20% by weight of at least one of a polyolefin and a compound comprising a glycidyl group.

4. The insulated conductor according to claim 2, wherein:
the hydrogenated block copolymer comprises a PS-polyethylene/butylene-PS triblock copolymer.

5. The insulated conductor according to claim 3, wherein:
the hydrogenated block copolymer comprises a PS-polyethylene/butylene-PS triblock copolymer.

6. The insulated conductor according to claim 2, wherein:
the polyolefin comprises a low-density polyethylene, and
the compound comprising the glycidyl group comprises an ethylene-glycidyl methacrylate copolymer.

7. The insulated conductor according to claim 3, wherein:
the polyolefin comprises a low-density polyethylene, and
the compound comprising the glycidyl group comprises an ethylene-glycidyl methacrylate copolymer.

8. The insulated conductor according to claim 1, wherein:
the resin composition further comprises 5 to 40% by weight of a nitrogen-containing compound with respect to 100% by weight of the resin composition.

9. The insulated conductor according to claim 3, wherein:
the resin composition further comprises 5 to 40% by weight of a nitrogen-containing compound with respect to 100% by weight of the resin composition.

10. The insulated conductor according to claim 1, wherein:
the insulation comprises a thickness of 0.01 mm to 0.3 mm.

11. The insulated conductor according to claim 3, wherein:
the insulation comprises a thickness of 0.01 mm to 0.3 mm.

12. A method for manufacturing an insulated conductor, comprising:
forming on the conductor the insulation comprising the resin composition according to claim 1 by extrusion in a range of 290° C. to 310° C.

13. A method for manufacturing an insulated conductor, comprising:
forming on the conductor the insulation comprising the resin composition according to claim 3 by extrusion in a range of 290° C. to 310° C.
